(19) United States
(12) Patent Application Publication
(10) Pub. No.: US 2026/0203327 A1
(43) Pub. Date: Jul. 16, 2026

(54) KNOWLEDGE-AWARE QUERY EXPANSION WITH LARGE LANGUAGE MODELS FOR TEXTUAL AND RELATIONAL RETRIEVAL

(71) Applicant: ADOBE INC., SAN JOSE, CA (US)

(72) Inventors: Yu Xia, La Jolla, CA (US); Sungchul Kim, San Jose, CA (US); Ryan A. Rossi, San Jose, CA (US); Tong Yu, Fremont, CA (US); Haoliang Wang, Sunnyvale, CA (US)

(21) Appl. No.: 19/018,497

(22) Filed: Jan. 13, 2025

(51) Int. Cl. G06F 16/3332; G06F 16/334

(52) U.S. Cl. CPC G06F 16/3338; G06F 16/3344

(57) ABSTRACT

A method, apparatus, non-transitory computer readable medium, and system for obtaining a query comprising a document request. A language generation model is configured to retrieve a first document based on the query and generate an expanded query based on the first document using a knowledge graph that connects the first document to a second document. A third document is retrieved based on the expanded query in response to the query.

### BACKGROUND

The following generally relates to machine learning, and more specifically to document retrieval using a machine learning model. Machine learning algorithms build a model based on sample data, known as training data, to make a prediction or a decision in response to an input without being explicitly programmed to do so. One area of application for machine learning is natural language processing.

Natural language processing (NLP) refers to techniques for using computers to interpret or generate natural language. In some cases, NLP tasks involve assigning annotation data such as grammatical information to words or phrases within a natural language expression. In some cases, NLP tasks include performing document retrieval based on a user query. For example, NLP based methods are used to retrieve a relevant document from a collection of, for example, documents in a database, in response to a user query.

### SUMMARY

The present disclosure describes systems and methods for natural language processing, more specifically to document retrieval. Embodiments of the present disclosure include a natural language processing apparatus configured to retrieve a document based on an input query (e.g., a user-provided text query). In some examples, the retrieved document is semantically similar and structurally related to the input query. According to an embodiment, a language generation model of the natural language processing apparatus receives an input query and expands the query to perform document retrieval. For example, the expanded query is descriptive and search-oriented. In some cases, the language generation model is augmented with a knowledge graph while utilizing textual documents and document relations on the knowledge graph as retrieval sources.

A method, apparatus, and non-transitory computer readable medium for natural language processing are described. One or more aspects of the method, apparatus, and non-transitory computer readable medium include obtaining a query comprising a document request; retrieving a first document based on the query; generating, using a language generation model, an expanded query based on the first document using a knowledge graph that connects the first document to a second document; and retrieving, in response to the query, a third document based on the expanded query.

A method, apparatus, and non-transitory computer readable medium for natural language processing are described. One or more aspects of the method, apparatus, and non-transitory computer readable medium include retrieving a first document based on a query; identifying a second document related to the first document; generating, using a language generation model, an expanded query based on the second document; and retrieving, in response to the query, a third document based on the expanded query.

An apparatus and system for natural language processing are described. One or more aspects of the apparatus and system include a memory component; a processing device coupled to the memory component, the processing device configured to perform operations comprising: obtaining a query comprising a document request; retrieving a first document based on the query; generating, using a language generation model, an expanded query based on the first document using a knowledge graph that connects the first document to a second document; and retrieving, in response to the query, a third document based on the expanded query.

### BRIEF DESCRIPTION OF THE DRAWINGS

FIG. 1 shows an example of a natural language processing system according to aspects of the present disclosure.

FIG. 2 shows an example of a method for retrieving a document according to aspects of the present disclosure.

FIG. 3 shows an example of a document retrieval process according to aspects of the present disclosure.

FIG. 4 shows an example of a query expansion framework according to aspects of the present disclosure.

FIG. 5 shows an example of a transformer architecture according to aspects of the present disclosure.

FIG. 6 shows an example of a method for natural language processing according to aspects of the present disclosure.

FIG. 7 shows an example of a method for natural language processing according to aspects of the present disclosure.

FIG. 8 shows an example of a method of training a machine learning model according to aspects of the present disclosure.

FIG. 9 shows an example of a computing device according to aspects of the present disclosure.

FIG. 10 shows an example of a natural language processing apparatus according to aspects of the present disclosure.

FIG. 11 shows an example of a machine learning model according to aspects of the present disclosure.

### DETAILED DESCRIPTION

The present disclosure describes systems and methods for natural language processing, more specifically to document retrieval. Embodiments of the present disclosure include a natural language processing apparatus configured to retrieve a document based on an input query (e.g., a user-provided text query). In some examples, the retrieved document is semantically similar and structurally related to the input query. According to an embodiment, a language generation model of the natural language processing apparatus receives an input query and expands the query to perform document retrieval. For example, the expanded query is descriptive and search-oriented. In some cases, the language generation model is augmented with a knowledge graph while utilizing textual documents and document relations on the knowledge graph as retrieval sources.

Existing systems use knowledge graph-based methods for document retrieval. However, in some cases, existing systems are unable to capture associations between textual descriptions and relational requirement of an element. For example, in case of a query such as “Find me a highly rated camera for wildlife photography compatible with my Nikon F-Mount Lenses” that specifies textual requirement of a product as “highly rated” and “wildlife photography”, and relational requirement of the product as “compatible with Nikon F-Mount lenses”, existing document retrieval systems may generate suboptimal retrieval documents. In some examples, such systems can hallucinate on the structured document relations and may retrieve camera such as a “Nikon Coolpix P1000” which is not compatible with “Nikon F-Mount lenses”.

Moreover, existing systems are only focused on providing answers to fact-focused queries in knowledge graph question answering tasks. In some cases, existing systems are unable to retrieve information from multiple sources. For example, such systems face challenges when an input query comprises information that is relevant to multiple sources (e.g., such systems rely on a single knowledge source for information retrieval). Therefore, there is a need in the art for a natural language processing system that can perform document retrieval from multiple sources, i.e., when a textual document and a document relation on a knowledge graph are sources for information retrieval.

Embodiments of the present disclosure include a natural language processing apparatus configured to retrieve a document based on generating an expansion to an input query. An embodiment of the present disclosure is configured to generate an expansion of the user-provided input query that is semantically similar as well as structurally related to user intent. In some cases, the natural language processing apparatus performs knowledge-aware query expansion based on augmenting the language generation model comprising a large language model (LLM) with structured document relations from a knowledge graph.

The present disclosure describes systems and methods for natural language processing, more specifically to knowledge-aware query expansion. According to an exemplary embodiment, the natural language processing apparatus of the present disclosure comprises a language generation model that is able to perform zero-shot query expansion for semi-structured queries with a textual requirement and a relational requirement. In some cases, the natural language processing apparatus leverages document texts such as knowledge graph node representations and utilizes document-based relation filtering for knowledge aware document retrieval.

According to an embodiment, the natural language processing apparatus uses a language generation model to extract an entity from a user-provided query. In some cases, an embedding model is used to obtain a text document corresponding to the query. According to an embodiment, the natural language processing apparatus is further configured to perform knowledge graph relation propagation by associating the obtained document with a corresponding node on the knowledge graph. Additionally, in some cases, the natural language processing apparatus obtains a set of neighbors for the node. For example, the set of neighbors are linked to the text document.

An embodiment of the present disclosure is configured to perform a document-based relation filtering. In some cases, the natural language processing apparatus is configured to compute a similarity score for obtaining a relevance between the nodes and the user-provided query. In some examples, the natural language processing apparatus computes the similarity score (i.e., a semantic similarity) based on an embedding of the retrieved document and an embedding of the user-provided query. In some examples, the natural language processing apparatus performs a filtering of the nodes to obtain query-focused neighbors (e.g., neighbor nodes).

According to an embodiment, the natural language processing apparatus is configured to generate a document-based knowledge triple. In some cases, the document-based knowledge triple is generated using the query-focused neighbors (i.e., filtered neighbor node and a corresponding relation). By generating the document-based knowledge triple, embodiments are able to leverage textual information in the document (e.g., instead of existing entity-based knowledge triples) and preserve structured relational knowledge from the knowledge graph to enhance the information accuracy.

In some cases, the language generation model takes the document-based knowledge triple and the user-provided query as input and accurately generates an expanded query. For example, the language generation model is configured to extract information from the document-based knowledge triple based on textual reasoning ability. In some examples, the expanded query is appended to the user-provided query and used for an embedding-based document retrieval.

As described herein, a query (e.g., the input query) refers to semi-structured data, such as text, processed to generate a desired output, such as predictions, classifications, etc. In some cases, the query comprises a structural aspect and a relational aspect. For example, the query comprises a document request, i.e., to obtain a target document that satisfies the structural (e.g., textual) aspect and the relational aspect of the query. In some cases, a document, such as the retrieved document, is provided to the user based on establishing a textual similarity and a relational similarity between the query and the document.

In some cases, the document retrieval is performed using an expanded query that is generated based on the input query. For example, the expanded query is generated by expanding the query (e.g., the input query) while utilizing additional context, such as semantic similarity and document-based relations, for optimized retrieval. In some examples, the expanded query is generated using a language generation model augmented with structured document relations from a knowledge graph.

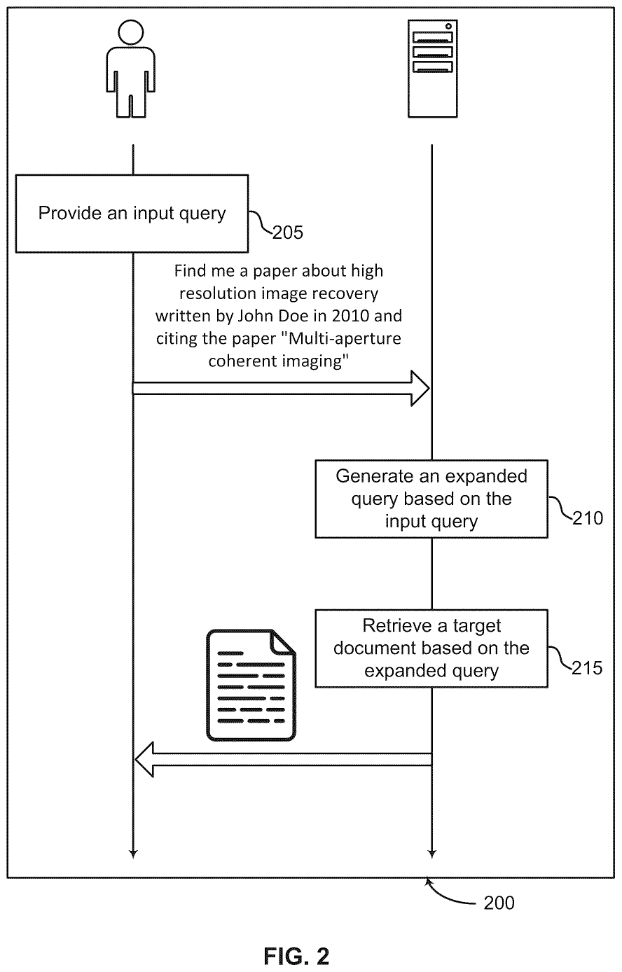

In some cases, the knowledge graph includes relationship information between a node representing a first entity and a node corresponding to a second entity. A knowledge graph captures node-edge relationship connecting items with their corresponding attributes in a non-Euclidean space. In some examples, the knowledge graph includes both homogenous information and heterogenous information. For example, the entities (represented as nodes in a knowledge graph) can be same or different types of objects. Further details regarding each of the query, the document, the document request, the expanded query, and the knowledge graph along with an explanatory example is provided with reference to at least FIGS. 2-4 and 6-7.

By computing the semantic similarity based on the document and the query, embodiments of the present disclosure are able to accurately obtain relevance information between the user-provided query and the neighboring node by utilizing textual details of the document (e.g., instead of only entity names). Additionally, by computing the semantic similarity while utilizing the embedding information, embodiments are able to prevent a retraining of the language generation model which results in significantly lower processing times and an enhancement of the scalability of the method (e.g., when a new node is added to the knowledge graph or a new document is added to the database).

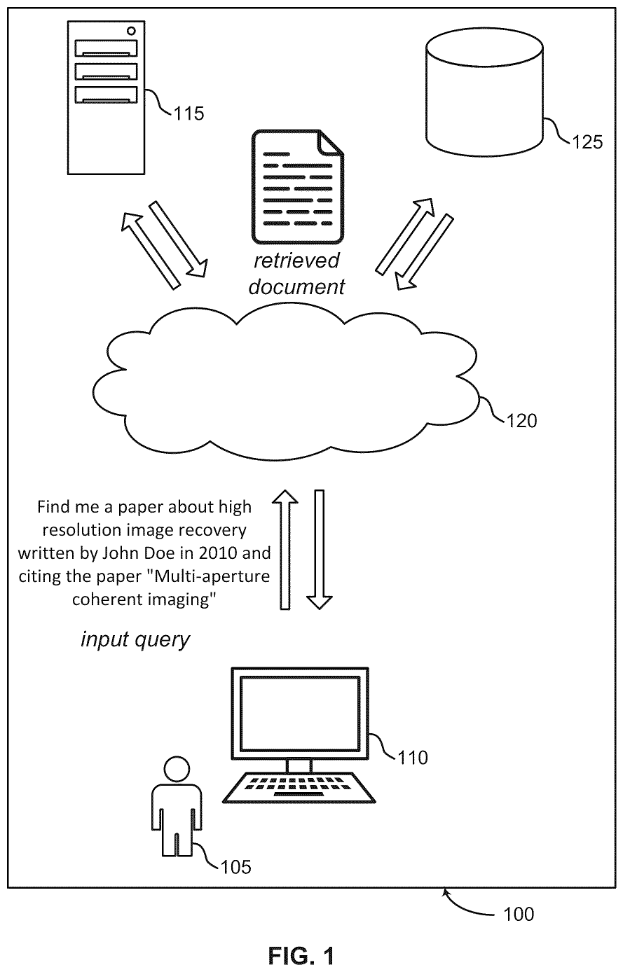

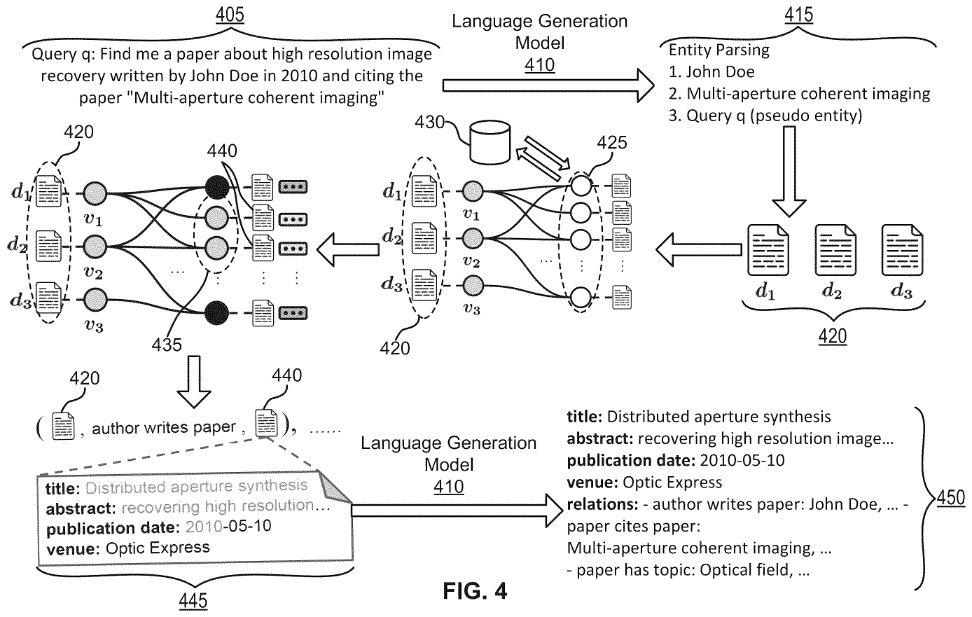

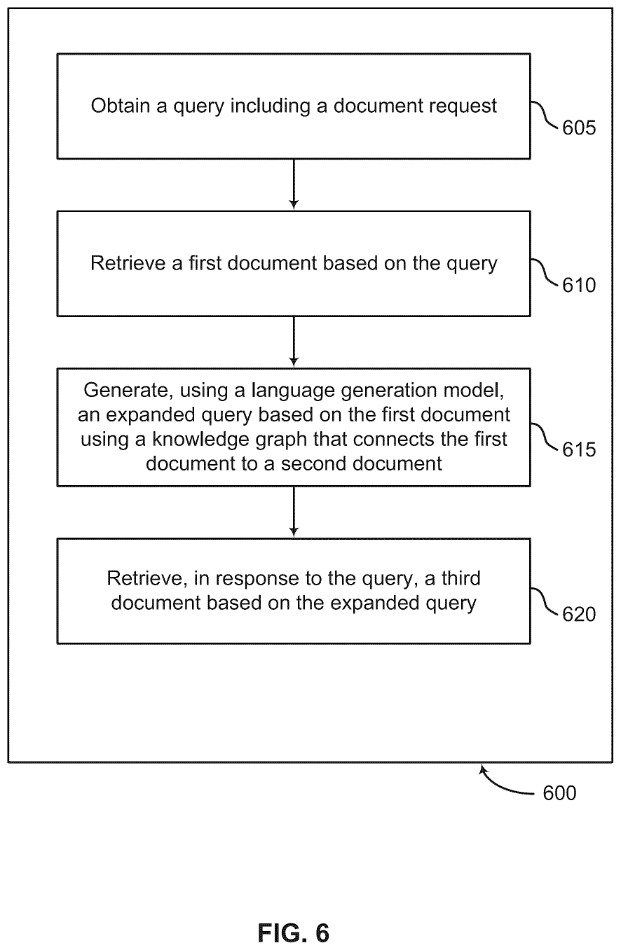

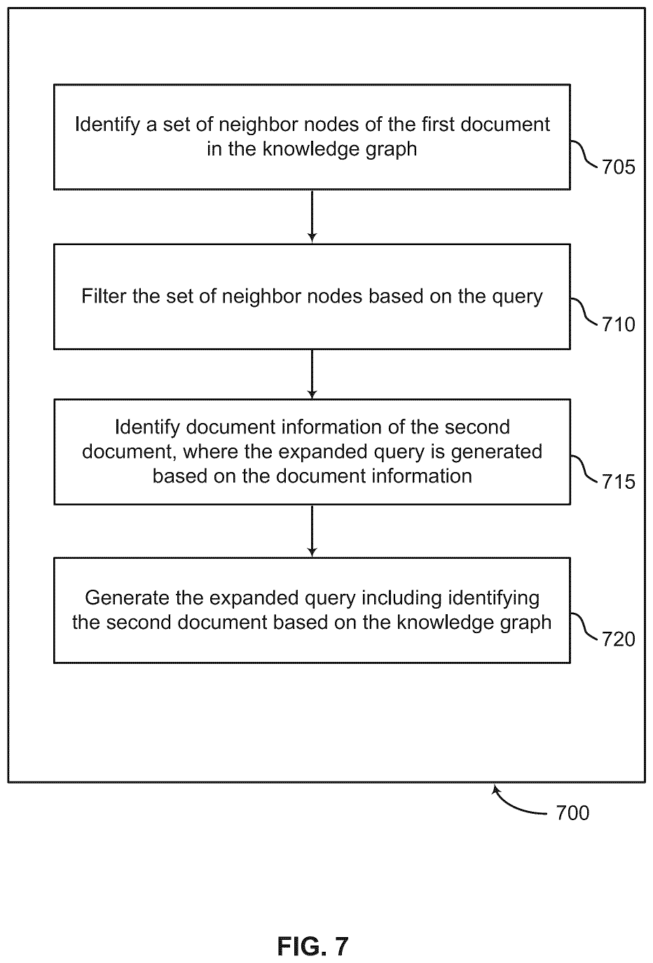

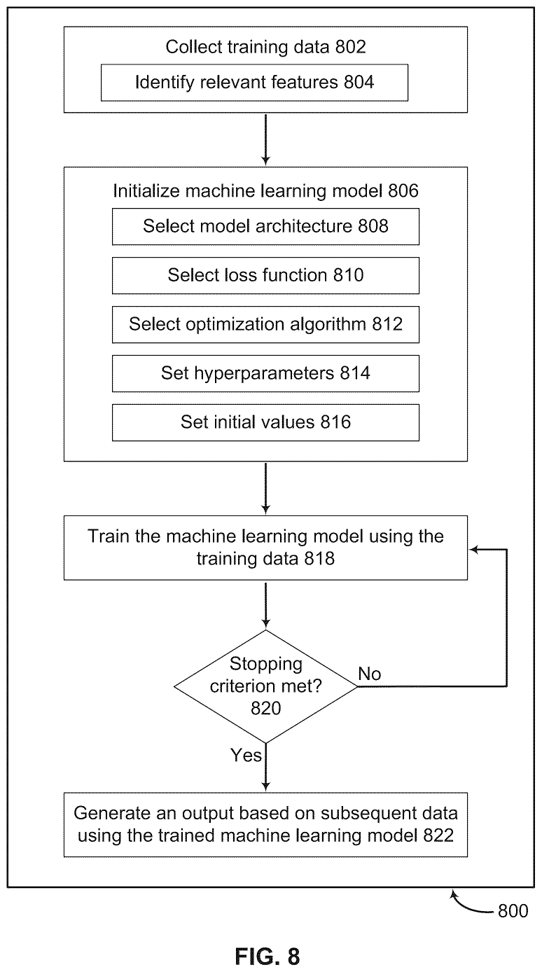

Embodiments of the present disclosure can be implemented in a document retrieval system. For example, the document retrieval system based on the present disclosure takes an input query and accurately retrieves a document that aligns with the textual requirement and the relational requirement of the input query. Example applications regarding retrieving the document are provided with reference to FIG. 1-3. Details regarding the architecture of the language generation model are provided with reference to FIGS. 4-5 and 9-11. Details regarding an operation of the language generation model are provided with reference to FIGS. 6-7. Examples of a process for training the language generation model are provided with reference to FIG. 8.

### Document Retrieval System

A system and an apparatus for document retrieval are described with reference to FIGS. 1-5. FIG. 1 shows an example of a natural language processing system 100 according to aspects of the present disclosure. In one aspect, natural language processing system 100 includes user 105, user device 110, natural language processing apparatus 115, cloud 120, and database 125.

In the example of FIG. 1, user 105 provides a query describing a request for a document to natural language processing apparatus 115 via a user interface provided on user device 110 by natural language processing apparatus 115. In some cases, the query is a text-based query. As used herein, the input query indicates a document that the user wants to retrieve. According to some aspects, natural language processing apparatus 115 obtains an input query, i.e., comprising request for a document (e.g., “Find me a paper about high resolution image recovery written by John Doe in 2010 and citing the paper “Multi-aperture coherent imaging”).

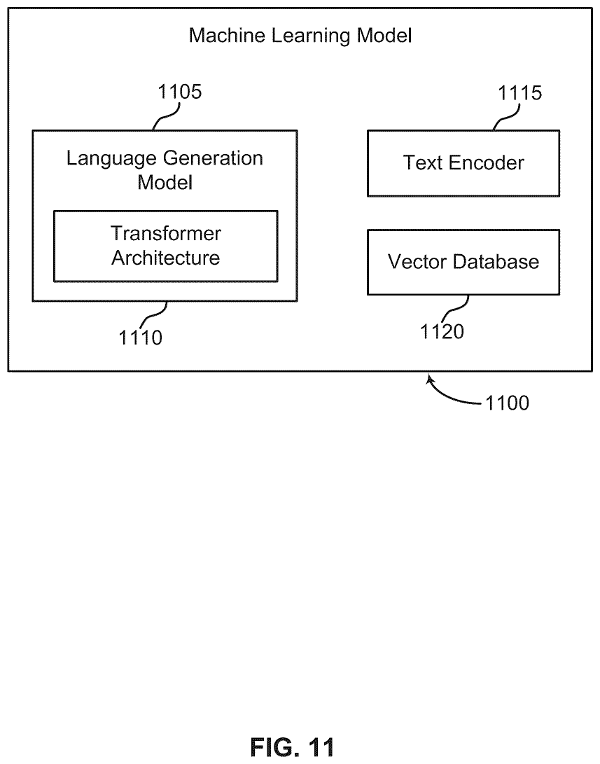

In some cases, the natural language processing apparatus 115 implements a language generation model (such as the language generation model described with reference to at least FIGS. 4 and 11) to retrieve a document that utilizes the textual and relational aspects of the input query. In some cases, as shown in FIG. 1, the user provides an input query to the natural language processing apparatus 115, aspects of which the user wants to obtain in the retrieved document. In some examples, the natural language processing apparatus accurately performs a knowledge-aware retrieval of a document based on the input query. For example, as shown in FIG. 1, the natural language processing apparatus provides an output (i.e., a retrieved document) that correctly captures the text and relations in the input query.

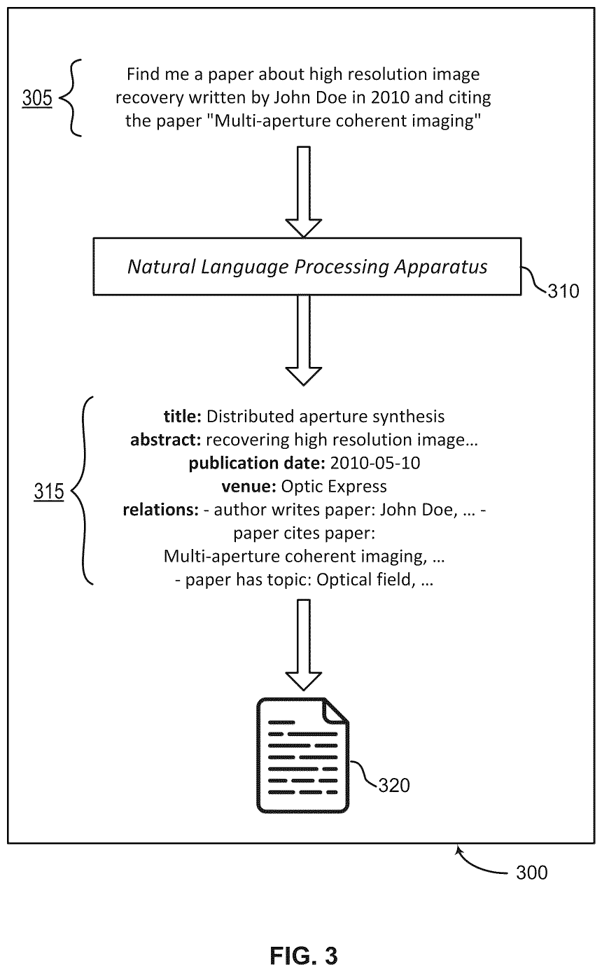

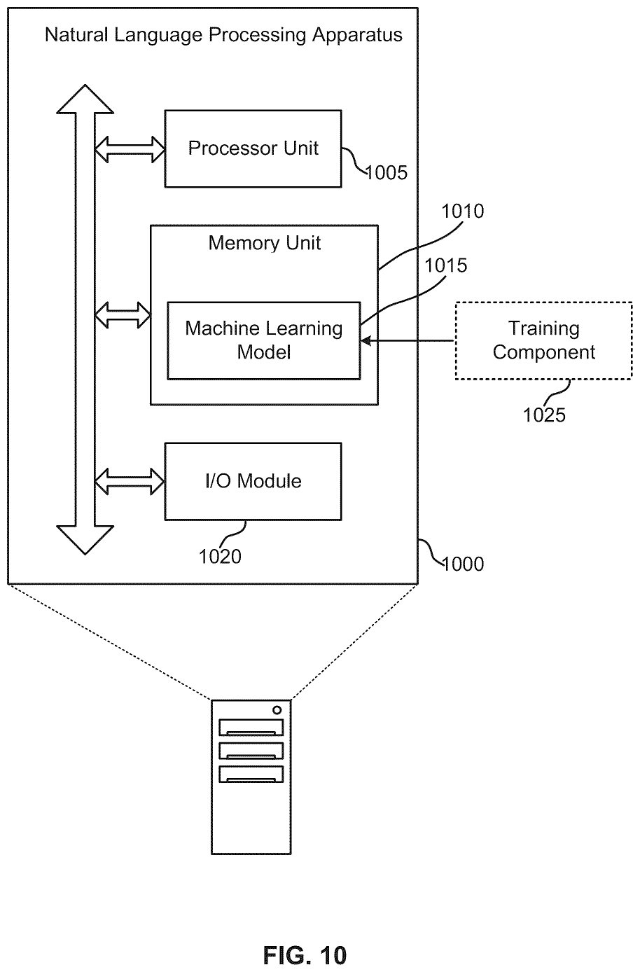

Referring to the example of FIG. 1, the natural language processing apparatus 115 provides the retrieved document to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by natural language processing apparatus 115. In some aspects, the user interface provides for information (such as documents, prompt, etc.) to be communicated between user 105 and natural language processing apparatus 115. Natural language processing apparatus 115 is an example of, or includes aspects of, the corresponding element described with reference to at least FIGS. 3 and 10.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

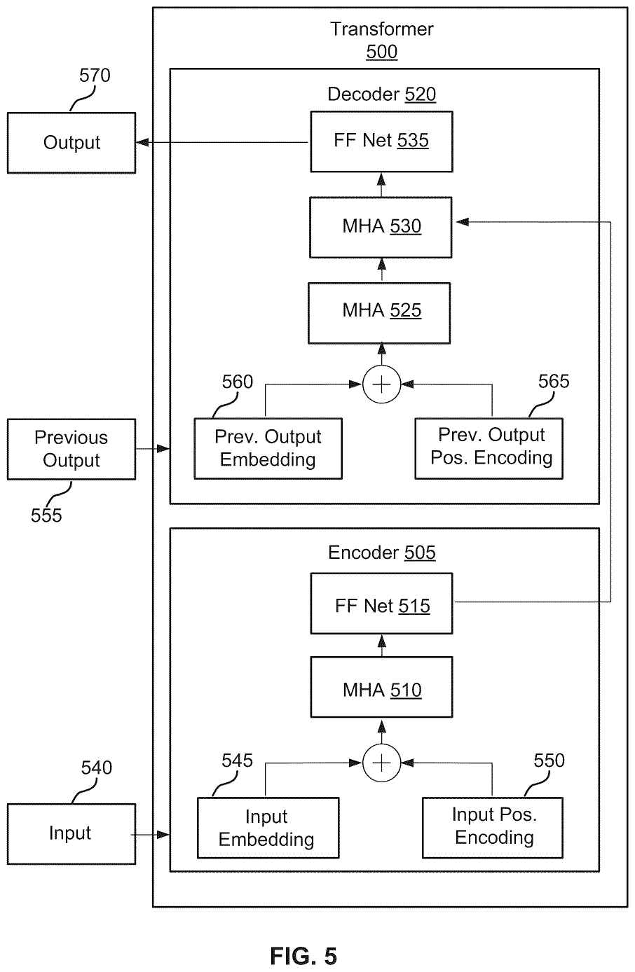

According to some aspects, natural language processing apparatus 115 includes a computer-implemented network. In some embodiments, the computer-implemented network includes a machine learning model (such as the machine learning model described with reference to FIGS. 4-5). In some embodiments, natural language processing apparatus 115 also includes one or more processors, a memory subsystem, a communication interface, an I/O interface, one or more user interface components, and a bus as described with reference to FIG. 13. Additionally, in some embodiments, natural language processing apparatus 115 communicates with user device 110 and database 125 via cloud 120.

In some cases, natural language processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, natural language processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to natural language processing apparatus 115 and communicates with natural language processing apparatus 115 via cloud 120. According to some aspects, database 125 is included in natural language processing apparatus 115.

FIG. 2 shows an example of a method 200 for retrieving a document according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, a natural language processing apparatus (such as the natural language processing apparatus described with reference to FIGS. 3 and 10) provides a machine learning model (such as the machine learning model described with reference to FIGS. 4-5 and 10-11) that accurately retrieves a document based on an input query. In some cases, the natural language processing apparatus is configured to perform an expansion of the input query to generate an expanded query, wherein the document retrieval is performed based on the expanded query.

At operation 205, the system provides an input query. In some cases, the operations of this step refer to, or may be performed by, a user as described with reference to FIG. 1.

In some examples, the user provides a query to the natural language processing apparatus (such as the natural language processing apparatus described with reference to FIG. 1). As shown in FIG. 2, the query provides information related to a document that the user wants to retrieve. For example, the user wants the retrieve a document as specified in the query “Find me a paper about high resolution image recovery written by John Doe in 2010 and citing the paper “Multi-aperture coherent imaging”. In some cases, the user provides the query to the natural language processing apparatus via a user interface (such as a graphical user interface) provided on a user device by the natural language processing apparatus.

At operation 210, the system generates an expanded query based on the input query. In some cases, the operations of this step refer to, or may be performed by, a natural language processing apparatus as described with reference to FIG. 10.

An embodiment of the present disclosure is configured to receive an input query and perform a query expansion of the input query to generate an expanded query. In some cases, the expanded query is able to augment the input query and provide for accurate and/or appropriate information search. The natural language processing apparatus is configured to generate the expanded query that considers the textual similarity and relation between the input query and a target document.

For example, in case of a query such as “Find me a highly rated camera for wildlife photography compatible with my Nikon F-Mount lenses”, the natural language processing apparatus generates an expanded query that is structurally related and semantically similar to user intent. For example, the natural language processing apparatus generates an expanded query such as “Title: Nikon Z7 II; Feature: 45.7 megapixels; autofocus . . . ; Description: wildlife flexible lens adapter . . . ; Reviews: 4.5/5 “autofocus fast animals . . . “; Relations: products also bought: Nikon F-Mount lenses, . . . products also viewed: FTZ adapter, . . . ”.

As described herein (and with reference to at least FIGS. 3-4 and 6-7), the expanded query explicitly provides relation information (e.g., “Relations: products also bought: Nikon F-Mount lenses, . . . products also viewed: FTZ adapter, . . . ”) in addition to the textual information (e.g., “Title: Nikon Z7 II; Feature: 45.7 megapixels; autofocus . . . ; Description: wildlife flexible lens adapter . . . ; Reviews: 4.5/5 “autofocus fast animals . . . ””).

Embodiments of the present disclosure are configured to perform query expansion accurately by utilizing document relation from a knowledge graph. In some examples, a document relation (i.e., customers bought “Nikon Z7 II” and “F-Mount lenses” together) is used to generate semantically similar and structurally related expanded query. In some cases, the natural language processing apparatus includes a language generation model that is augmented with a structured document relation from the knowledge graph. In some cases, the natural language processing apparatus is configured to utilize document text as knowledge graph node representation for relation propagation in the knowledge graph. Additionally, the natural language processing apparatus is configured to use document-based relation filtering for generating the expanded query. Further details regarding the process of generating the expanded query are provided with reference to FIGS. 4 and 6-7.

At operation 215, the system retrieves a target document based on the expanded query. In some cases, the operations of this step refer to, or may be performed by, a natural language processing apparatus as described with reference to FIG. 10.

In some cases, the expanded query is utilized for an embedding-based document retrieval. For example, the natural language processing apparatus is able to accurately retrieve a document by incorporating aspects of the expanded query. For example, in some cases, the natural language processing apparatus displays the retrieved document to the user via the user interface (such as the user interface described with reference to FIG. 1).

In some cases, the natural language processing apparatus performs a zero-shot query expansion while collaboratively leveraging textual documents and knowledge graph relations. In some cases, the natural language processing apparatus efficiently utilizes document texts for node representations of a knowledge graph. For example, the natural language processing apparatus is not additionally finetuned and hence is scalable and flexible when additional documents are added to the knowledge base.

FIG. 3 shows an example of a document retrieval process 300 according to aspects of the present disclosure. In one aspect, document retrieval process 300 includes query 305, natural language processing apparatus 310, expanded query 315, and third document 320.

Referring to FIG. 3, query 305 describes a request for a document a user wants to retrieve. In some cases, query 305 is a search query with a textual and relational requirement. For instance, query 305 specifies the requirement as “Find me a paper about high resolution image recovery written by John Doe in 2010 and citing the paper “Multi-aperture coherent imaging”. Query 305 is an example of, or includes aspects of, the corresponding element described with reference to FIG. 4.

The natural language processing apparatus 310 of the present disclosure receives the query 305 from the user. In some cases, natural language processing apparatus 310 is configured to expand the query 305 to generate expanded query 315. In some cases, expanded query 315 is generated by providing additional context, enhancing semantic similarity of third document 320 (e.g., target document) while capturing different relations between inter-connected documents. For example, query 305 specifies the textual requirement of the paper in “high resolution image recovery” and “2010”, and relational requirement of the paper in “John Doe” and “Multi-aperture coherent imaging”.

Natural language processing apparatus 310 includes a knowledge-aware query expansion framework that augments the language generation model (such as language generation model 410 described with reference to FIG. 4) comprising an LLM and a transformer network (such as transformer network 500 described with reference to FIG. 5) with structured document relations from the knowledge graph. For example, natural language processing apparatus 310 is configured to obtain a plurality of textual documents and associated nodes and relations on the knowledge graph based on entities present in query 305. In some examples, natural language processing apparatus 310 leverages text in the obtained documents as node representations of the knowledge graph.

Additionally, natural language processing apparatus 310 uses document-based relation filtering to extract query-focused relations. Natural language processing apparatus 310 takes the textual and relational knowledge as input and generates expanded query 315. For example, expanded query 315 is grounded to document corpus and preserves user-specified document relations. Natural language processing apparatus 310 is an example of, or includes aspects of, the corresponding element described with reference to FIG. 1. Expanded query 315 is an example of, or includes aspects of, the corresponding element described with reference to FIG. 4.

The expanded query 315 is used for retrieval (e.g., knowledge-aware retrieval) of the third document 320. For example, as shown in FIG. 3, the expanded query is “title: Distributed aperture synthesis; abstract: recovering high resolution image . . . ; publication date: 2010 May 10; venue: Optic Express; relations: author writes paper: John Doe, . . . paper cites paper: Multi-aperture coherent imaging, . . . ; paper has topic: Optical field, . . . ”. Third document 320 is retrieved based on the expanded query 315. Third document 320 is an example of, or includes aspects of, the corresponding element described with reference to FIG. 6.

FIG. 4 shows an example of a query expansion framework according to aspects of the present disclosure. In one aspect, query expansion framework 400 includes query 405, language generation model 410, entity 415, first document 420, unfiltered neighbor node 425, vector database 430, neighbor node 435, second document 440, document triple 445, and expanded query 450.

For example, as shown in FIG. 4, query 405 states “Find me a paper about high resolution image recovery written by John Doe in 2010 and citing the paper “Multi-aperture coherent imaging”. Query 405 is an example of, or includes aspects of, the corresponding element described with reference to FIG. 3.

Language generation model 410 is configured to extract explicitly mentioned entities (such as entity 415) from query 405 for a given document structure. For example, entity 415 for query 405 related to a paper (such as a journal article or a publication) search includes author name, paper title, and the user-provided query. In some examples, as shown in FIG. 4, entity 415 comprises “1. John Doe; 2. Multi-aperture coherent imaging; 3. Query q (pseudo entity)”. In some examples, language generation model 410 is a large language model (LLM).

LLMs work by processing vast amounts of text data during the training phase. LLMs learn patterns, relationships between words, and how to predict the next word or phrase based on context. LLMs are trained on enormous datasets, such as books, articles, websites, and other written material and use the data to learn the statistical relationships between words and phrases. Text input is divided into smaller units called tokens, such as words or subwords. Each token has an associated vector representation that the model uses to understand and generate text. The model analyzes sequences of tokens to understand the context of each word or phrase which enables generation of text that is coherent and contextually appropriate. Language generation model 410 is an example of, or includes aspects of, the corresponding element described with reference to FIG. 11.

According to an embodiment, the natural language processing apparatus implements a text embedding model to retrieve an associated textual document (e.g., first document 420 dᵢ) for each entity 415. In some cases, the associated textual document is obtained from a collection of textual documents. For example, a document d₁ among the first document 420 for the query 405 related to a paper (such as a journal article or a publication) search includes an author document comprising information of the journal article and citation count (i.e., author name: John Doe; paper count: 2; citation count: 31).

Additionally or alternatively, the associated textual document for the query 405 related to a paper (such as a journal article or a publication) search includes a paper document comprising abstract and publication information (e.g., date and venue). For example, a document d₂ among the first document 420 includes information such as “title: Multi-aperture coherent imaging; abstract: Aperture synthesis offers . . . ; publication date: 2011 May 13; venue: Proceedings of SPIE”. In some examples, another document d₃ among the first document 420 includes information such as “title: Single shot high resolution; abstract: We demonstrate a novel . . . ; publication date: 2013 Feb. 11; venue: Optics Express”.

In some cases, the natural language processing apparatus associates each document among first document 420 to the corresponding entity node (e.g., unfiltered neighbor node 425). For example, natural language processing apparatus associates each document (e.g., d₁, d₂, d₃) to unfiltered neighbor node 425 on a knowledge graph based on the semi-structured knowledge base. In some examples, the vector representations (e.g., unfiltered neighbor node 425) are stored in a vector database 430. Vector database 430 is an example of, or includes aspects of, the corresponding element described with reference to FIG. 11.

Embodiments of the present disclosure include a language generation model augmented with structured document relations from the knowledge graph. Some embodiments generate a knowledge graph including relationship information between a node representing a first document 420 and nodes corresponding to a second document 440 (e.g., a set of second documents). A knowledge graph captures node-edge relationship connecting items with their corresponding attributes in a non-Euclidean space. In some examples, the knowledge graph includes both homogenous information and heterogenous information. For example, entities such as first document and second document (represented as nodes in a knowledge graph) can be same or different types of objects. In some cases, a knowledge graph includes a spatial encoding matrix representing a number of hops between nodes of the knowledge graph, and an edge encoding matrix representing edge types between nodes of the knowledge graph.

As shown in FIG. 4, the natural language processing apparatus is configured to extract the associated h-hop neighbors (e.g., unfiltered neighbor node 425) for each node (e.g., 11, 12, 123) based on the knowledge graph relations in the knowledge graph. For example, in case of the query 405 related to a paper (such as a journal article or a publication) search, the relation includes, but is not limited to, “author writes paper”, “paper cites paper”, etc. Additionally, each neighbor node (e.g., unfiltered neighbor node 425) is linked to a corresponding textual document.

In some cases, for example in case of a dense knowledge graph, a node includes a large number of neighbors including nodes that are irrelevant to the query (e.g., unfiltered neighbor node 425). The natural language processing apparatus of the present disclosure filters relevant queries to obtain neighbor node 435 (as indicated in grey color in FIG. 4; black nodes are irrelevant and removed after the filtering process) and the corresponding second document 440 (e.g., plurality of second documents; dⱼ). Further details regarding the filtering process are provided with reference to FIGS. 5-6.

An embodiment of the present disclosure is configured to construct a document-based knowledge triple (i.e., document triple 445) based on the textual information. In some cases, the document triple 445 is generated based on the filtered neighbor nodes (e.g., neighbor node 435) and relations. For example, the document triple recites a relation between dᵢ and dⱼ. For example, the relation on knowledge graph includes, but not limited thereto, “author writes paper”, “paper cites paper”. The document triple 445 provides textual detail and structured relational knowledge from a knowledge graph to enhance the information accuracy.

Language generation model 410 is configured to take the document triple 445 and query 405 as input and generate expanded query 450. In some cases, language generation model 410 is able to implement textual reasoning ability to extract information from the document triple 445. For example, language generation model 410 generates expanded query 450 that enables answering of query 405. Expanded query 450 is an example of, or includes aspects of, the corresponding element described with reference to FIG. 3. The expanded query 450 is used for an embedding-based document retrieval.

Embodiments of the present disclosure are configured to perform textual and relational retrieval based on a knowledge-aware query expansion framework. In some cases, the knowledge graph relations are used between textual documents to enhance generation of an expanded query by a language generation model. According to an embodiment, the natural language processing apparatus is configured to collaboratively leverage textual and relational knowledge to perform a filtering of query-focused relations with document texts. For example, the natural language processing apparatus is configured to filter knowledge graph node representations for knowledge-aware retrieval. In some examples, the natural language processing apparatus of the present disclosure performs significantly accurate document retrieval. In some examples, the natural language processing apparatus is applicable to a complex search query with textual and relational requirements.

FIG. 5 shows an example of a transformer network 500 according to aspects of the present disclosure. The example shown includes transformer 500, encoder 505, decoder 520, input 540, input embedding 545, input positional encoding 550, previous output 555, previous output embedding 560, previous output positional encoding 565, and output 570. According to some aspects, encoder 505 is implemented as a text encoder of a multi-modal encoder (such as the text encoder 1520 described with reference to FIG. 15). According to some aspects, encoder 505 is implemented as a text encoder of conditional text encoder (such as the text encoder 1115 described with reference to FIG. 11). According to some aspects, transformer 500 is implemented in the language generation model (such as the language generation model 410 described with reference to FIG. 4). According to some aspects, transformer 500 is implemented in the document retrieval network.

In some cases, encoder 505 includes multi-head self-attention sublayer 510 and feed-forward network sublayer 515. In some cases, decoder 520 includes first multi-head self-attention sublayer 525, second multi-head self-attention sublayer 530, and feed-forward network sublayer 535.

In some cases, encoder 505 is configured to map input 540 (for example, a text prompt) to a sequence of continuous representations that are fed into decoder 520. In some cases, decoder 520 generates output 570 (e.g., a prediction of an output sequence of words or tokens) based on the output of encoder 505 and previous output 555 (e.g., a previously predicted output sequence), which allows for the use of autoregression.

For example, in some cases, encoder 505 parses input 540 into tokens and vectorizes the parsed tokens to obtain input embedding 545, and adds input positional encoding 550 (e.g., positional encoding vectors for input 540 of a same dimension as input embedding 545) to input embedding 545. In some cases, input positional encoding 550 includes information about relative positions of words or tokens in input 540.

In some cases, encoder 505 comprises one or more encoding layers that generate contextualized token representations, where each representation corresponds to a token that combines information from other input tokens via self-attention mechanism. In some cases, each encoding layer of encoder 505 comprises a multi-head self-attention sublayer (e.g., multi-head self-attention sublayer 510). In some cases, the multi-head self-attention sublayer implements a multi-head self-attention mechanism that receives different linearly projected versions of queries, keys, and values to produce outputs in parallel. In some cases, each encoding layer of encoder 505 also includes a fully connected feed-forward network sublayer (e.g., feed-forward network sublayer 515) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 540.

In some cases, each sublayer of encoder 505 is followed by a normalization layer that normalizes a sum computed between a sublayer input x and an output sublayer (x) generated by the sublayer:

$$layernorm ( x + sublayer ( x ) ) \qquad ( 2 )$$

In some cases, encoder 505 is bidirectional because encoder 505 attends to each word or token in input 540 regardless of a position of the word or token in input 540.

According to some aspects, encoder 505 functions as a text encoder of the conditional text encoder (such as the text encoder 1115 described with reference to FIG. 11). In an example, conditional text encoder splits an input text into fixed-size segments, generates a linear embedding of each of the segments, adds position embeddings to each of the linear embeddings, and provides the resulting sequence of vectors as input 540 to encoder 505.

In some cases, decoder 520 comprises one or more decoding layers (e.g., six decoding layers). In some cases, each decoding layer comprises three sublayers including a first multi-head self-attention sublayer (e.g., first multi-head self-attention sublayer 525), a second multi-head self-attention sublayer (e.g., second multi-head self-attention sublayer 530), and a feed-forward network sublayer (e.g., feed-forward network sublayer 535). In some cases, each sublayer of decoder 520 is followed by a normalization layer that normalizes a sum computed between a sublayer input x and an output sublayer (x) generated by the sublayer.

In some cases, decoder 520 generates previous output embedding 560 of previous output 555 and adds previous output positional encoding 565 (e.g., position information for words or tokens in previous output 555) to previous output embedding 560. In some cases, each first multi-head self-attention sublayer receives the combination of previous output embedding 560 and previous output positional encoding 565 and applies a multi-head self-attention mechanism to the combination. In some cases, for each word in an input sequence, each first multi-head self-attention sublayer of decoder 520 attends only to words preceding the word in the sequence, and so a prediction of transformer 500 for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 505 by receiving a query Q from a previous sublayer of decoder 520 and a key K and a value V from the output of encoder 505, allowing decoder 520 to attend to each word in the input 540.

In some cases, each feed-forward network sublayer implements a fully connected feed-forward network similar to feed-forward network sublayer 515. In some cases, the feed-forward network sublayers are followed by a linear transformation and a softmax to generate a prediction of output 570.

Accordingly, an apparatus for natural language processing is described. One or more aspects of the apparatus include a memory component; a processing device coupled to the memory component, the processing device configured to perform operations comprising: obtaining a query comprising a document request; retrieving a first document based on the query; generating, using a language generation model, an expanded query based on the first document using a knowledge graph that connects the first document to a second document; and retrieving, in response to the query, a third document based on the expanded query.

Some examples of the apparatus and system further include a vector database storing the second document and the third document. In some aspects, the language generation model comprises a transformer architecture. In some aspects, the processing device is further configured to perform operations comprising identifying the second document based on the knowledge graph. Some examples further include identifying document information of the second document, wherein the expanded query is generated based on the document information.

Some examples of the apparatus and system further include identifying a plurality of neighbor nodes of the first document in the knowledge graph. Some examples further include filtering the plurality of neighbor nodes based on the query. In some aspects, the processing device is further configured to perform operations comprising generating a document triple indicating the first document, a relation, and the second document, wherein the expanded query is generated based on the document triple.

### Document Retrieval Process

The present disclosure describes systems and methods for document retrieval. Embodiments of the present disclosure include a natural language processing apparatus comprising a knowledge-aware query expansion framework that augments a language generation model with a knowledge graph. In some cases, the natural language processing apparatus is able to handle a complex input search query (e.g., an input query) with a textual requirement and a relational requirement and accurately generate an expanded query based on the complex input search query.

In some cases, the expanded query captures the semantic similarity between a target document and the input search query. Additionally, in some cases, the expanded query captures the inter-document relations between a document of a database. For example, the natural language processing apparatus augments the language generation model with structured document relations from the knowledge graph for performing semi-structured document retrieval. In some examples, the natural language processing apparatus uses text of the document as node representation of the knowledge graph. In some cases, the natural language processing apparatus is configured to perform a document-based relation filtering for the document retrieval.

Accordingly, by augmenting the language generation model with the knowledge graph, embodiments of the present disclosure are able to perform document retrieval even when the input query is descriptive and domain-specific. Additionally, by implementing the textual documents and the knowledge graph as a semi-structured knowledge source with information covering diverse aspects, embodiments are able to perform effective knowledge extraction and document retrieval.

FIG. 6 shows an example of a method 600 for natural language processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

Embodiments of the present disclosure are configured to perform query expansion for textual and relational semi-structured retrieval. In some cases, a knowledge base comprises a collection of textual documents [symbol] and a knowledge graph [symbol] =( [symbol] , [symbol] ), where dᵢ∈ [symbol] is a textual document describing an entity i. In some cases, vᵢ∈ [symbol] is the corresponding entity node on the knowledge graph. In some cases, [symbol] is a set of relations between different nodes.

For example, in case of a query related to a paper search (i.e., as described with reference to FIG. 4), each paper i has a textual document dᵢ including, but not limited to, abstract, venue, publication date. Additionally, the corresponding node vᵢ on the knowledge graph [symbol] encodes the relations with other nodes (e.g., paper citations, authorship, field of study, etc. according to the example of the paper search in FIG. 4).

In some cases, based on the given query, the semi-structured retrieval includes outputting a set of documents [symbol] (i.e., [symbol] ∈ [symbol] ) such that the entity (such as entity 415 described in FIG. 4) in each document satisfies the textual and relational requirements specified by query q.

At operation 605, the system obtains a query including a document request. In some cases, the operations of this step refer to, or may be performed by, a natural language processing apparatus as described with reference to FIG. 10.

In some cases, the natural language processing apparatus of the present disclosure obtains a query q (such as query 405 described with reference to at least FIG. 4) from the user via a user interface of the user device (such as user interface and user device described with reference to at least FIG. 1). For example, the query q includes requirements from unstructured texts in the collection of textual documents [symbol] and structured relations in the knowledge graph [symbol] .

The natural language processing apparatus comprises a language generation model (such as language generation model 410 described with reference to FIG. 4 and language generation model 1105 described with reference to FIG. 11). The language generation model is used to extract explicitly mentioned entities from the original user-provided query q for a given document structure. In some examples, the document structure is denoted by ε_{q}. In some cases, the user-provided query q is a pseudo entity representing a target entity document to be retrieved:

$${ε}_{q} = \{ q , LLM ( q ) \} \qquad ( 3 )$$

For example, an entity for a user-provided query related to a paper (such as a journal article or a publication) search includes author name, paper title, and the user-provided query.

At operation 610, the system retrieves a first document based on the query. In some cases, the operations of this step refer to, or may be performed by, a language generation model as described with reference to FIGS. 4 and 11.

The natural language processing apparatus implements a text embedding model (such as text encoder 1115 described with reference to FIG. 11) to retrieve an associated textual document dᵢ (e.g., first document 420 described with reference to FIG. 4) from [symbol] for each entity i∈Σ_{q} (e.g., entity 415 as described with reference to FIG. 4). For example, an associated textual document for the query q (e.g., user-provided query) related to a paper (such as a journal article or a publication) search includes an author document comprising information of the journal article and citation count. Additionally or alternatively, the associated textual document for the query q related to a paper (such as a journal article or a publication) search includes a paper document comprising abstract and publication information (e.g., date and venue).

At operation 615, the system generates, using a language generation model, an expanded query based on the first document using a knowledge graph that connects the first document to a second document. In some cases, the operations of this step refer to, or may be performed by, a language generation model as described with reference to FIGS. 4 and 11.

In some cases, the natural language processing apparatus associates a document to the corresponding entity node vᵢ∈ [symbol] on a knowledge graph based on the semi-structured knowledge base. The natural language processing apparatus is configured to extract the associated h-hop neighbors for each node vᵢ based on the knowledge graph relations in [symbol] . In some cases, the set of the h-hop neighbors is denoted as Nᵢ and the corresponding relations to vᵢ as the set Rᵢ. In some examples, in case of the user-provided query related to a paper (such as a journal article or a publication) search, the relation is, but not limited to, “author writes paper”, “paper cites paper”. Similarly, each neighbor node vⱼ∈Nᵢ is linked to the corresponding textual document dⱼ.

In some cases, for example in case of a dense knowledge graph, a node includes a large number of neighbors including nodes that are irrelevant to the query. The natural language processing apparatus of the present disclosure filters relevant queries while considering the textual details of the entities (i.e., instead of scoring relevance between nodes and queries based on entity names). For example, an entity name in the knowledge graph for paper search is a paper title. In some examples, additional details of the paper include, but not limited thereto, the abstract content (e.g., “high resolution image recovery”) and publication information (e.g., year “2020”).

An embodiment of the present disclosure is configured to use associated document texts and document-based relation filtering. For example, the natural language processing apparatus is configured to leverage document text such as a rich representation of knowledge graph nodes and the relation filtering to obtain a query-focused relation. Further details regarding the filtering process are provided with reference to at least FIG. 7.

An embodiment of the present disclosure is configured to construct a document-based knowledge triple based on the textual information. In some cases, the document-based knowledge triple (such as document triple 445 described with reference to FIG. 4) is generated based on the filtered neighbor nodes and relations.

$${𝒯}_{i , q} = \{ ( {d}_{i} , {r}_{i , j} , {d}_{j} ) \vert {v}_{j} ∈ {N}_{i , q} , {r}_{i , j} ∈ {ℛ}_{i , q} \} \qquad ( 4 )$$

where r_{i,j} denotes the relation on knowledge graph from node vᵢ to node vⱼ. In some examples, the relation on knowledge graph includes, but not limited thereto, paper cites paper. dᵢ and dⱼ are document texts associated with vᵢ and vⱼ including details of a node. For example, the details on each node include, but not limited thereto, paper abstract, venue, and publication date. The document triple provides textual detail and structured relational knowledge from a knowledge graph to enhance the information accuracy.

The language generation model is configured to take the document triples [symbol] _{q} and the user-provided query q as input and generate text. The language generation model is able to implement textual reasoning ability to extract information from the document triples [symbol] _{q}. In some cases, the language generation model generates query expansion that enable answering of the query q:

$${𝒬}_{e} = LLM ( q , {𝒯}_{q} ) \qquad ( 5 )$$

At operation 620, the system retrieves, in response to the query, a third document based on the expanded query. In some cases, the operations of this step refer to, or may be performed by, a natural language processing apparatus as described with reference to FIG. 10. In some cases, during an inference time, the language generation model samples n responses and concatenates the responses as the final expansion appended to the user-provided query.

In some cases, the natural language processing apparatus is configured to augment the query q with the expanded query [symbol] ₑ. For example, the natural language processing apparatus performs the augmentation based on the available textual and relational knowledge (i.e., to bridge the gap between query and documents).

$${𝒬}_{e} = f ( q , 𝒟 , 𝒢 ) \qquad ( 6 )$$

$${q}^{′} = Concat ( q , {𝒬}_{e} ) \qquad ( 7 )$$

where f represents the query expansion function and the expansion is appended to query q as the expanded query q′ for retrieval of the third document (such as third document described with reference to FIG. 3). The expanded query q′ is used for an embedding-based document retrieval (i.e., retrieval of the third document, such as third document described with reference to FIG. 3).

FIG. 7 shows an example of a method 700 for natural language processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, the system identifies the second document including identifying a set of neighbor nodes of the first document in the knowledge graph. In some cases, the operations of this step refer to, or may be performed by, a language generation model as described with reference to FIGS. 4 and 11.

As described with reference to FIG. 6, the natural language processing apparatus of the present disclosure comprises a language generation model (such as language generation model 410 described with reference to FIG. 4 and language generation model 1105 described with reference to FIG. 11). In some cases, the language generation model is configured to associate the first document (such as first document 420 described with reference to FIG. 4 and first document described with reference to FIG. 6) to the corresponding entity node vᵢ∈ [symbol] on a knowledge graph based on the semi-structured knowledge base. The language generation model is configured to extract the associated h-hop neighbors for each node vᵢ based on the knowledge graph relations in knowledge graph [symbol] . In some cases, each neighbor node vⱼ∈Nᵢ is linked to the corresponding textual document dⱼ.

At operation 710, the system filters the set of neighbor nodes based on the query. In some cases, the operations of this step refer to, or may be performed by, a language generation model as described with reference to FIGS. 4 and 11.

In some cases, for example in case of a dense knowledge graph, a node includes a large number of neighbors including nodes that are irrelevant to the query (e.g., unfiltered neighbor nodes 425 described with reference to FIG. 4). The natural language processing apparatus of the present disclosure filters relevant queries while considering the textual details of the entities (i.e., instead of scoring relevance between nodes and queries based on entity names). For example, an entity name in knowledge graph for paper search is a paper title. In some examples, additional details of the paper include, but not limited thereto, the abstract content (e.g., “high resolution image recovery”) and publication information (e.g., year “2020”).

An embodiment of the present disclosure is configured to use associated document texts and document-based relation filtering. For example, the natural language processing apparatus is configured to leverage document text such as a representation (e.g., a rich representation) of knowledge graph nodes and the relation filtering to obtain a query-focused relation. In some cases, a text embedding model of the natural language processing apparatus embeds the textual document dⱼ for a neighbor node as xⱼ=Embed (dⱼ) for the given set of neighbor nodes Nᵢ. Additionally, in some cases, the text embedding model embeds the user-provided query as x_{q}=Embed (q). The semantic similarity of the node v; with the query q is computed as:

$${s}_{j , q} = S i m ( {x}_{j} , {x}_{q} ) \qquad ( 8 )$$

As shown herein, equation 8 is able to accurately capture the relevance between the user-provided query and the neighbor node by using the textual details in addition to the entity name. The top-k scored nodes are selected as query-focused neighbors based on the similarity score.

$${𝒩}_{i , q} = \{ {v}_{j} ∈ {N}_{i} \vert {s}_{j , q} ∈ TopK ( {s}_{q} ) \} \qquad ( 9 )$$

In some cases, the top-k scored nodes are used to derive the corresponding query-focused relations [symbol] _{i,q}⊆ [symbol] ᵢ.

At operation 715, the system identifies document information of the second document, where the expanded query is generated based on the document information. In some cases, the operations of this step refer to, or may be performed by, a language generation model as described with reference to FIGS. 4 and 11.

In some cases, the language generation model is further configured to construct a document-based knowledge triple (e.g., document triple 445 described with reference to FIG. 4) based on textual information of the filtered document (e.g., second document 440 described with reference to FIG. 4). In some cases, the document-based knowledge triple is generated based on the filtered neighbor nodes and relations.

In some cases, as described with reference to FIG. 6, the document-based knowledge triple describes a relation on knowledge graph from node vᵢ to node vⱼ along with document texts associated with vᵢ and vⱼ including details of a node. In some cases, the document triple provides textual detail and structured relational knowledge from a knowledge graph for generation of the expanded query (such as expanded query 450 described with reference to FIG. 4 and expanded query described with reference to FIG. 6).

At operation 720, the system generates the expanded query including identifying the second document based on the knowledge graph. In some cases, the operations of this step refer to, or may be performed by, a language generation model as described with reference to FIGS. 4 and 11.

Embodiments of the present disclosure are configured to collaboratively leverage textual documents and knowledge graph relations. In some cases, the natural language processing apparatus performs knowledge-aware retrieval based on the query expansion. Embodiments are not limited to any LLM and text embedding model. By using document texts for knowledge graph node representations and not using additional model finetuning, embodiments are able to provide a scalable and flexible query expansion method even when new documents are added to the knowledge base.

Accordingly, a method for natural language processing is described. One or more aspects of the method include obtaining a query comprising a document request; retrieving a first document based on the query; generating, using a language generation model, an expanded query based on the first document using a knowledge graph that connects the first document to a second document; and retrieving, in response to the query, a third document based on the expanded query.

Some examples of the method, apparatus, and non-transitory computer readable medium further include retrieving the first document comprises: extracting an entity from the query. Some examples further include retrieving the first document based on the extracted entity. Some examples of the method, apparatus, and non-transitory computer readable medium further include retrieving the first document comprises: encoding at least a portion of the query to obtain a query embedding. Some examples further include comparing the query embedding to a first document embedding representing the first document, wherein the first document is retrieved based on the comparison.

Some examples of the method, apparatus, and non-transitory computer readable medium further include generating the expanded query comprises identifying the second document based on the knowledge graph. Some examples further include identifying document information of the second document, wherein the expanded query is generated based on the document information. Some examples of the method, apparatus, and non-transitory computer readable medium further include identifying the second document comprises: identifying a plurality of neighbor nodes of the first document in the knowledge graph. Some examples further include filtering the plurality of neighbor nodes based on the query.

Some examples of the method, apparatus, and non-transitory computer readable medium further include generating the expanded query comprises generating a document triple indicating the first document, a relation, and the second document, wherein the expanded query is generated based on the document triple. Some examples of the method, apparatus, and non-transitory computer readable medium further include retrieving the third document comprises: encoding the expanded query to obtain an expanded query embedding. Some examples further include comparing the expanded query embedding to a third document embedding representing the third document, wherein the third document is retrieved based on the comparison.

Additionally, a method for natural language processing is described. One or more aspects of the method include retrieving a first document based on a query; identifying a second document related to the first document; generating, using a language generation model, an expanded query based on the second document; and retrieving, in response to the query, a third document based on the expanded query.

Some examples of the method, apparatus, and non-transitory computer readable medium further include extracting an entity from the query and retrieving the first document based on the extracted entity. Some examples of the method, apparatus, and non-transitory computer readable medium further include encoding at least a portion of the query to obtain a query embedding and comparing the query embedding to a first document embedding representing the first document, wherein the first document is retrieved based on the comparison.

Some examples of the method, apparatus, and non-transitory computer readable medium further include identifying the second document based on a knowledge graph and identifying document information of the second document, wherein the expanded query is generated based on the document information. Some examples of the method, apparatus, and non-transitory computer readable medium further include identifying a plurality of neighbor nodes of the first document in the knowledge graph and filtering the plurality of neighbor nodes based on the query.

Some examples of the method, apparatus, and non-transitory computer readable medium further include generating a document triple indicating the first document, a relation, and the second document, wherein the expanded query is generated based on the document triple. Some examples of the method, apparatus, and non-transitory computer readable medium further include encoding the expanded query to obtain an expanded query embedding and comparing the expanded query embedding to a third document embedding representing the third document, wherein the third document is retrieved based on the comparison.

### Training

FIG. 8 shows an example of a method of training a machine learning model according to aspects of the present disclosure. FIG. 8 is a flow diagram depicting an algorithm as a step-by-step procedure 800 in an example implementation of operations performable for training a machine-learning model. In some embodiments, the procedure 800 describes an operation of the training component 1025 described for configuring the machine learning model 1015 as described with reference to FIG. 10. The procedure 800 provides one or more examples of generating training data, use of the training data to train a machine-learning model, and use of the trained machine-learning model to perform a task.

To begin in this example, a machine-learning system collects training data (block 802) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 806). Initialization of the machine-learning model includes selecting a model architecture (block 808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 810). The loss function is utilized to measure a difference between an output of the machine-learning model (i.e., predictions) and target values (e.g., as expressed by the training data) to be used to train the machine-learning model. Additionally, an optimization algorithm is selected (812) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 814) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 820), the procedure 800 continues training of the machine-learning model using the training data (block 818) in this example.

If the stopping criterion is met (“yes” from decision block 820), the trained machine-learning model is then utilized to generate an output based on subsequent data (block 822). The trained machine-learning model, for instance, is trained to perform a task as described above and therefore, once trained is configured to perform that task based on subsequent data received as an input and processed by the machine-learning model. The machine learning model is an example of, or includes aspects of, the corresponding element described with reference to FIGS. 2, 4, 6-7, and 10-11.

### Implementation and Evaluation

An exemplary embodiment of the present disclosure is configured to perform an evaluation of the natural language processing apparatus. In some examples, the natural language processing apparatus is evaluated on three textual and relational semi-structured retrieval datasets. For example, the datasets include textual information and dense relations. According to an exemplary embodiment, the natural language processing apparatus is evaluated with a plurality of baselines and ablated variants in a zero-shot setting.

An exemplary embodiment of the present disclosure is configured to perform an LLM-based query expansion. In some examples, Azure OpenAI API for GPT-40 is used as the backbone LLM. In some cases, additional results are provided using LLaMA-3.1-8B-Instruct. For example, dense embeddings from OpenAI text-embedding-ada-002 model are used for query expansion. In some examples, the similarity computation and document retrieval is performed using dot product. In some examples, additional results for sparse retrieval is performed using a probabilistic relevance framework. In some examples, the input is truncated when the length of the input exceeds the context window of the backbone LLM or the text embedding model.

The experiments are performed on NVIDIA A 100-SXM4-80G GPU. In some examples, a hyperparameter n=3 for methods using the top-n initial retrieval results. In some examples, the knowledge graph parameter h=2 for h-hop neighbors. In some examples, k=10 to select top-k neighbors for query-focused relations.

According to an exemplary embodiment, the natural language processing apparatus is able to consistently achieve high performance on a test set of synthetic queries. By consistently achieving high performance, embodiments of the present disclosure are able to prove efficacy on textual and relational retrieval and generalizability to real-world scenarios.

Embodiments of the present disclosure are configured to incorporate document texts and relations for enhancing the retrieval accuracy. In some cases, the natural language processing apparatus provides highly relevant documents even in case of dense relation structures. In some cases, the natural language processing apparatus includes a large language model comprising an LLM comprising an intrinsic knowledge that can mitigate the textual semantic gap between queries and documents. In some cases, the natural language processing apparatus is based on a knowledge graph that provides the structured relation knowledge.

Embodiments of the present disclosure are configured to perform textual and relational retrieval based on a knowledge-aware query expansion framework. In some cases, the knowledge graph relations are used between textual documents to enhance generation of an expanded query by a language generation model. According to an embodiment, the natural language processing apparatus is configured to collaboratively leverage textual and relational knowledge to perform a filtering of query-focused relations with document texts. For example, the natural language processing apparatus is configured to filter knowledge graph node representations for knowledge-aware retrieval.

Additionally, an exemplary embodiment of the present disclosure is configured to evaluate a performance of the natural language processing apparatus on a semi-structured retrieval dataset of diverse domains. In some examples, the natural language processing apparatus of the present disclosure performs significantly accurate document retrieval. In some examples, the natural language processing apparatus is applicable to a real-world complex search query.

### Computing Device

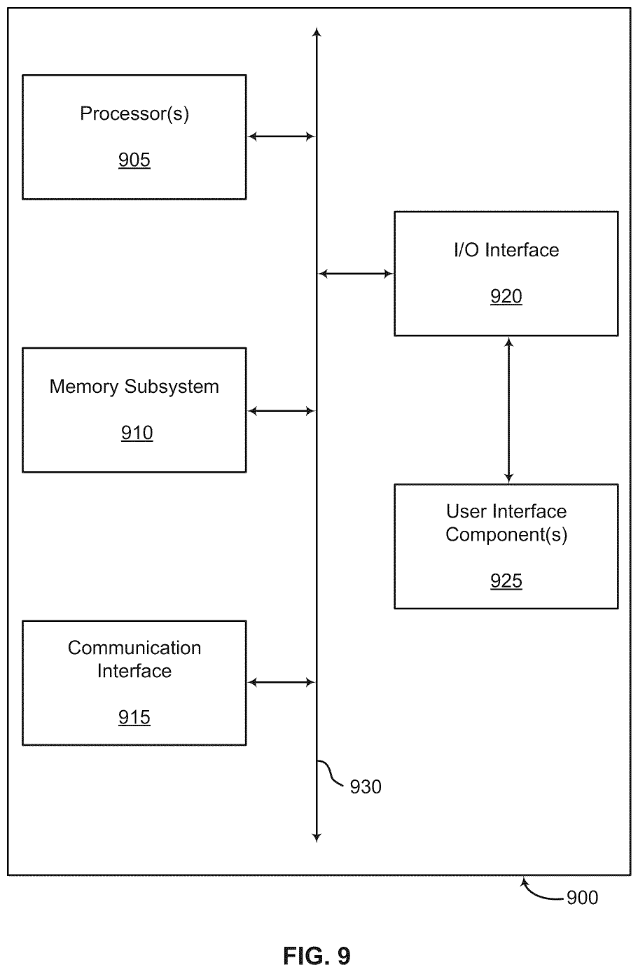

FIG. 9 shows an example of a computing device according to aspects of the present disclosure. The computing device 900 may be an example of the natural language processing apparatus 1000 described with reference to FIG. 10. In one aspect, computing device 900 includes processor(s) 905, memory subsystem 910, communication interface 915, I/O interface 920, user interface component(s) 925, and channel 930.

In some embodiments, computing device 900 is an example of, or includes aspects of, the machine learning model of FIGS. 10-11. In some embodiments, computing device 900 includes one or more processors 905 that can execute instructions stored in memory subsystem 910 to perform document retrieval.

According to some aspects, computing device 900 includes one or more processors 905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enable a user to interact with computing device 900. In some cases, user interface component(s) 925 include an audio device, such as an external speaker system, an external display device such as a display screen, an input device (e.g., a remote-control device interfaced with a user interface directly or through the I/O controller), or a combination thereof. In some cases, user interface component(s) 925 include a GUI.

FIG. 10 shows an example of a natural language processing apparatus 1000 according to aspects of the present disclosure. Natural language processing apparatus 1000 is an example of, or includes aspects of, the corresponding element described with reference to FIGS. 1 and 3. In one aspect, natural language processing apparatus 1000 includes processor unit 1005, memory unit 1010, I/O module 1020, and training component 1025. Training component 1025 updates parameters of the machine learning model 1015 stored in memory unit 1010. In some examples, the training component 1025 is located outside the natural language processing apparatus 1000.

According to some aspects, natural language processing apparatus 1000 obtains a query including a document request. In some examples, natural language processing apparatus 1000 retrieves, in response to the query, a third document based on the expanded query.

According to some aspects, natural language processing apparatus 1000 comprises obtaining a query including a document request. In some examples, natural language processing apparatus 1000 comprises retrieving, in response to the query, a third document based on the expanded query.

Processor unit 1005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1005 is configured to operate a memory array using a memory controller. In other cases, a memory controller is integrated into processor unit 1005. In some cases, processor unit 1005 is configured to execute computer-readable instructions stored in memory unit 1010 to perform various functions. In some aspects, processor unit 1005 includes special purpose components for modem processing, baseband processing, digital signal processing, or transmission processing. According to some aspects, processor unit 1005 comprises one or more processors described with reference to FIG. 9.

Memory unit 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1005 to perform various functions described herein.

In some cases, memory unit 1010 includes a basic input/output system (BIOS) that controls basic hardware or software operations, such as an interaction with peripheral components or devices. In some cases, memory unit 1010 includes a memory controller that operates memory cells of memory unit 1010. For example, the memory controller may include a row decoder, column decoder, or both. In some cases, memory cells within memory unit 1010 store information in the form of a logical state. According to some aspects, memory unit 1010 is an example of the memory subsystem 910 described with reference to FIG. 9.

According to some aspects, natural language processing apparatus 1000 uses one or more processors of processor unit 1005 to execute instructions stored in memory unit 1010 to perform functions described herein. For example, the natural language processing apparatus 1000 may obtain a query comprising a document request; retrieve a first document based on the query; generate, using a language generation model, an expanded query based on the first document using a knowledge graph that connects the first document to a second document; and retrieve, in response to the query, a third document based on the expanded query.

In one aspect, memory unit 1010 includes machine learning model 1015 trained to obtain a query comprising a document request; retrieve a first document based on the query; generate, using a language generation model, an expanded query based on the first document using a knowledge graph that connects the first document to a second document; and retrieve, in response to the query, a third document based on the expanded query.

For example, after training, the machine learning model 1015 may perform inferencing operations as described with reference to FIGS. 1-3 to obtain a query comprising a document request; retrieve a first document based on the query; generate, using a language generation model, an expanded query based on the first document using a knowledge graph that connects the first document to a second document; and retrieve, in response to the query, a third document based on the expanded query.

In some embodiments, the machine learning model 1015 is an Artificial neural network (ANN) comprising a plurality of networks including the transformer model described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1015 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1025 may train the machine learning model 1015. For example, parameters of the machine learning model 1015 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 8). The goal of the training process may be to find optimal values for the parameters that allow the language generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1015 can be used to make predictions on new, unseen data (i.e., during inference). Machine learning model 1015 is an example of, or includes aspects of, the corresponding element described with reference to FIG. 11.

I/O module 1020 receives inputs from and transmits outputs of the natural language processing apparatus 1000 to other devices or users. For example, I/O module 1020 receives inputs for the machine learning model 1015 and transmits outputs of the machine learning model 1015. According to some aspects, I/O module 1020 is an example of the I/O interface 920 described with reference to FIG. 9.

FIG. 11 shows an example of a machine learning model 1100 according to aspects of the present disclosure. Machine learning model 1100 is an example of, or includes aspects of, the corresponding element described with reference to FIG. 10. In one aspect, machine learning model 1100 includes language generation model 1105, text encoder 1115, and vector database 1120.

According to some aspects, language generation model 1105 retrieves a first document based on the query. In some examples, language generation model 1105 generates an expanded query based on the first document using a knowledge graph that connects the first document to a second document. In some examples, language generation model 1105 retrieves the first document including extracting an entity from the query. In some examples, language generation model 1105 retrieves the first document based on the extracted entity. In some examples, language generation model 1105 compares the query embedding to a first document embedding representing the first document, where the first document is retrieved based on the comparison. In some examples, language generation model 1105 generates the expanded query including identifying the second document based on the knowledge graph.

In some examples, language generation model 1105 identifies document information of the second document, where the expanded query is generated based on the document information. In some examples, language generation model 1105 identifies the second document including identifying a set of neighbor nodes of the first document in the knowledge graph. In some examples, language generation model 1105 filters the set of neighbor nodes based on the query. In some examples, language generation model 1105 generates the expanded query including generating a document triple indicating the first document, a relation, and the second document, where the expanded query is generated based on the document triple 445. In some examples, language generation model 1105 compares the expanded query embedding to a third document embedding representing the third document, where the third document is retrieved based on the comparison.

According to some aspects, language generation model 1105 retrieves a first document based on a query. In some examples, language generation model 1105 identifies a second document related to the first document. In some examples, language generation model 1105 generates an expanded query based on the second document.

According to some aspects, language generation model 1105 extracts an entity from the query. In some examples, language generation model 1105 retrieves the first document based on the extracted entity. According to some aspects, language generation model 1105 compares the query embedding to a first document embedding representing the first document, where the first document is retrieved based on the comparison.

According to some aspects, language generation model 1105 identifies the second document based on a knowledge graph. In some examples, language generation model 1105 identifies document information of the second document, where the expanded query is generated based on the document information.

According to some aspects, language generation model 1105 identifies a set of neighbor nodes of the first document in the knowledge graph. In some examples, language generation model 1105 filters the set of neighbor nodes based on the query.

According to some aspects, language generation model 1105 generates a document triple indicating the first document, a relation, and the second document, where the expanded query is generated based on the document triple. According to some aspects, language generation model 1105 compares the expanded query embedding to a third document embedding representing the third document, where the third document is retrieved based on the comparison.

According to some aspects, language generation model 1105 comprises retrieving a first document based on the query. In some examples, language generation model 1105 is used to generate an expanded query based on the first document using a knowledge graph that connects the first document to a second document. In some aspects, the language generation model 1105 includes a transformer architecture. In some aspects, the processing device is further configured to perform operations including identifying the second document based on the knowledge graph. In some examples, language generation model 1105 comprises identifying document information of the second document, where the expanded query is generated based on the document information.

In some examples, language generation model 1105 comprises identifying a set of neighbor nodes of the first document in the knowledge graph. In some examples, language generation model 1105 comprises filtering the set of neighbor nodes based on the query. In some aspects, the processing device is further configured to perform operations including generating a document triple indicating the first document, a relation, and the second document, where the expanded query is generated based on the document triple. Language generation model 1105 is an example of, or includes aspects of, the corresponding element described with reference to FIG. 4.

In one aspect, language generation model 1105 includes transformer architecture 1110. Transformer architecture 1110 is an example of, or includes aspects of, the corresponding element described with reference to FIG. 5.

According to some aspects, text encoder 1115 retrieves the first document including encoding at least a portion of the query to obtain a query embedding. In some examples, text encoder 1115 retrieves the third document including encoding the expanded query to obtain an expanded query embedding.

According to some aspects, text encoder 1115 encodes at least a portion of the query to obtain a query embedding. According to some aspects, text encoder 1115 encodes the expanded query to obtain an expanded query embedding.

An “embedding” refers to a representation of an object (e.g., the text prompt) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined. A “text embedding” refers to an embedding of the text prompt, e.g., a representation of the text prompt in an embedding space.

An “embedding space” (or a “vector space”) refers to a set having embeddings (or vectors) as elements and is characterized by a dimension specifying a number of independent directions in the embedding space. According to some aspects, the embedding space is a multi-modal embedding space that is shared by text embeddings and image embeddings, such that a text embeddings and an image embedding may be compared with each other.

Vector database 1120 is a data management system configured to store, index, and retrieve high-dimensional vector representations of data. The system comprises a data storage module for maintaining vector embeddings, where each embedding represents a data object, such as text, images, or other media. Vector database 1120 further includes an indexing engine that organizes vectors using techniques such as approximate nearest neighbor algorithms, including but not limited to hierarchical navigable small world (HNSW) graphs or inverted file (IVF) indices.

Vector database 1120 is configured to perform similarity searches, enabling efficient retrieval of vectors that are closest to a query vector based on predefined metrics, such as cosine similarity or Euclidean distance. In some cases, vector database 1120 facilitates applications including semantic search, recommendation systems, image and video retrieval, anomaly detection, and natural language processing.

According to an embodiment, vector database 1120 supports hybrid queries, combining vector-based similarity searches with traditional structured queries, such as filtering by metadata or applying conditional logic. In some cases, vector database 1120 further integrates with machine learning models to dynamically update or generate vector embeddings. The architecture is scalable and designed to handle billions of vectors, ensuring rapid query response times and robust data management for large-scale deployments. Vector database 1120 is an example of, or includes aspects of, the corresponding element described with reference to FIG. 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a query comprising a document request;
retrieving a first document based on the query;
generating, using a language generation model, an expanded query based on the first document using a knowledge graph that connects the first document to a second document; and
retrieving, in response to the query, a third document based on the expanded query.

2. The method of claim 1, wherein retrieving the first document comprises:
extracting an entity from the query; and
retrieving the first document based on the extracted entity.

3. The method of claim 1, wherein retrieving the first document comprises:
encoding at least a portion of the query to obtain a query embedding; and
comparing the query embedding to a first document embedding representing the first document, wherein the first document is retrieved based on the comparison.

4. The method of claim 1, wherein generating the expanded query comprises:
identifying the second document based on the knowledge graph; and
identifying document information of the second document, wherein the expanded query is generated based on the document information.

5. The method of claim 4, wherein identifying the second document comprises:
identifying a plurality of neighbor nodes of the first document in the knowledge graph; and
filtering the plurality of neighbor nodes based on the query.

6. The method of claim 1, wherein generating the expanded query comprises:
generating a document triple indicating the first document, a relation, and the second document, wherein the expanded query is generated based on the document triple.

7. The method of claim 1, wherein retrieving the third document comprises:
encoding the expanded query to obtain an expanded query embedding; and
comparing the expanded query embedding to a third document embedding representing the third document, wherein the third document is retrieved based on the comparison.

8. A non-transitory computer readable medium storing code for document retrieval, the code comprising instructions that, when executed by at least one processor, cause the at least one processor to perform operations comprising:
retrieving a first document based on a query;
identifying a second document related to the first document;
generating, using a language generation model, an expanded query based on the second document; and
retrieving, in response to the query, a third document based on the expanded query.

9. The non-transitory computer readable medium of claim 8, the code further comprising instructions that, when executed by the at least one processor, cause the at least one processor to perform operations comprising:
extracting an entity from the query; and
retrieving the first document based on the extracted entity.

10. The non-transitory computer readable medium of claim 8, the code further comprising instructions that, when executed by the at least one processor, cause the at least one processor to perform operations comprising:
encoding at least a portion of the query to obtain a query embedding; and
comparing the query embedding to a first document embedding representing the first document, wherein the first document is retrieved based on the comparison.

11. The non-transitory computer readable medium of claim 8, the code further comprising instructions that, when executed by the at least one processor, cause the at least one processor to perform operations comprising:
identifying the second document based on a knowledge graph; and
identifying document information of the second document, wherein the expanded query is generated based on the document information.

12. The non-transitory computer readable medium of claim 11, the code further comprising instructions that, when executed by the at least one processor, cause the at least one processor to perform operations comprising:
identifying a plurality of neighbor nodes of the first document in the knowledge graph; and
filtering the plurality of neighbor nodes based on the query.

13. The non-transitory computer readable medium of claim 8, the code further comprising instructions that, when executed by the at least one processor, cause the at least one processor to perform operations comprising:
generating a document triple indicating the first document, a relation, and the second document, wherein the expanded query is generated based on the document triple.

14. The non-transitory computer readable medium of claim 8, the code further comprising instructions that, when executed by the at least one processor, cause the at least one processor to perform operations comprising:
encoding the expanded query to obtain an expanded query embedding; and
comparing the expanded query embedding to a third document embedding representing the third document, wherein the third document is retrieved based on the comparison.

15. A system comprising:
a memory component; and
a processing device coupled to the memory component, the processing device configured to perform operations comprising:
obtaining a query comprising a document request;
retrieving a first document based on the query;
generating, using a language generation model, an expanded query based on the first document using a knowledge graph that connects the first document to a second document; and
retrieving, in response to the query, a third document based on the expanded query.

16. The system of claim 15, wherein the system further includes:
a vector database storing the second document and the third document.

17. The system of claim 15, wherein:
the language generation model comprises a transformer architecture.

18. The system of claim 15, wherein the processing device is further configured to perform operations comprising:
identifying the second document based on the knowledge graph; and
identifying document information of the second document, wherein the expanded query is generated based on the document information.

19. The system of claim 18, wherein the processing device is further configured to perform operations comprising:
identifying a plurality of neighbor nodes of the first document in the knowledge graph; and
filtering the plurality of neighbor nodes based on the query.

20. The system of claim 15, wherein the processing device is further configured to perform operations comprising:
generating a document triple indicating the first document, a relation, and the second document, wherein the expanded query is generated based on the document triple.
